(19) United States
(12) Patent Application Publication
(10) Pub. No.: US 2017/0272165 A1
(43) Pub. Date: Sep. 21, 2017

(54) Spatial Obfuscation of Optical Signal for Secure Data Transmission

(71) Applicants: Mohammad Mehdi MANSOURI RAD, Kanata (CA); Hamid MEHRVAR, Ottawa (CA); Mehdi Arashmid AKHAVAIN MOHAMMADI, Ottawa (CA)

(72) Inventors: Mohammad Mehdi MANSOURI RAD, Kanata (CA); Hamid MEHRVAR, Ottawa (CA); Mehdi Arashmid AKHAVAIN MOHAMMADI, Ottawa (CA)

(21) Appl. No.: 15/198,503

(22) Filed: Jun. 30, 2016

Related U.S. Application Data
(60) Provisional application No. 62/309,849, filed on Mar. 17, 2016.

(51) Int. Cl. H04B 10/2581; H04B 10/50; H04B 10/60

(52) U.S. Cl. CPC H04B 10/2581; H04B 10/60; H04B 10/50

(57) ABSTRACT

Transmitter, receiver, system and method for secure data communications are provided. The transmitter receives an optical signal from a signal source and transmits first and second version of the optical signal in first and second areas of an optical channel. The receiver receives first and second components of an obfuscated signal and modifies the first component before combining the modified first component and the second component to obtain a recovered optical signal.

### CROSS REFERENCE TO RELATED APPLICATIONS

This application claims the benefit of U.S. Provisional Patent Application Ser. No. 62/309,849, filed Mar. 17, 2016, the contents of which are incorporated herein by reference.

### TECHNICAL FIELD

The present disclosure relates to photonic networks, and more particularly, to a method and apparatus for physical transport layer obfuscation of optical signals for secure data transmission.

### BACKGROUND

Security of transmission plays a key role in high-reliability photonic networks, especially for financial organizations such as banks and government agencies. Many conventional security methods apply encryption in the digital domain. However, such methods allow any person who can get a copy of the physical signal with an acceptable signal quality to recover the encrypted signal and then begin an attack on the encryption. With data in its digitally encrypted form readily available, brute force computation can be employed to identify the applied digital encryption and subsequently retrieve the actual data. As well, increasing security level of digital encryption would usually result in a significant increase in the number, cost and complexity of hardware and/or software of the encryption and decryption systems.

In some environments, such as data centers, there is a need for different nodes to be connected to each other in a secure fashion. When this connection is within a single site data center, for example, between two server racks, the data center operator can provide a certain level of physical security to ensure that the connection is not being tapped by an intervening entity. However, when there is a need for inter-site communication (e.g. a node in a first data center communicating with a node in a second data center nodes at different sites within the same data center), the security of the data transmitted between the sites may not be as easy to ensure. The data center operator may encourage all customers to make use of digital encryption of their data, but this cannot be enforced. The data center operator may elect to provide encrypted tunnels between the sites to provide a further level of security. This introduces additional processing overhead for all inter-site traffic. This bulk encryption is an operational expense for the data center operator. If the data transmitted through the secure tunnel is intercepted, offline encryption attacks can still be utilized.

An improved mechanism for securing aggregated data transmissions over an optical channel may address some of the above described problems.

### SUMMARY

The following presents a summary of some aspects or embodiments of the disclosure in order to provide a basic understanding of the disclosure. This summary is not an extensive overview of the disclosure. It is not intended to identify key or critical elements of the disclosure or to delineate the scope of the disclosure. Its sole purpose is to present some embodiments of the disclosure in a simplified form as a prelude to the more detailed description that is presented later.

Disclosed herein is a method and apparatus which can be used to secure photonic layer links. According to various embodiments, an optical signal is spatially obfuscated by transmitting the optical signal in predetermined area(s) of the optical channel. The location of the predetermined area(s) used for transmission as well as any alterations made to the transmitted optical signal in the predetermined area(s) are unknown to any party except the intended receiver. A receiver, having knowledge of the spatial obfuscation can recover the data-carrying optical signal. An interloper without a priori knowledge of the particular obfuscation applied would not be able to detect the transmitted obfuscated signal, and thus would not be able to recover the data-carrying signal. The method and apparatus therefore allow a data-carrying optical signal to be obfuscated spatially during transmission.

In a first aspect of the present invention, there is provided a method of transmitting an optical signal carrying data in an optical channel. The method comprises receiving the optical signal carrying data from a signal source; and transmitting first and second versions of the received optical signal in first and second areas, respectively, of the optical channel.

In an embodiment of the first aspect of the present invention, the first version is a modified version of the received optical signal. In a further embodiment, the modification applied to the received optical signal to create the first version is an alteration of at least one of amplitude, phase, polarization, and dispersion of the received optical signal. In another embodiment, transmitting the first and second versions comprises modifying the optical signal by passing the optical signal through a mask to select the first and second areas of the optical channel. In another embodiment, transmitting further comprises controlling the mask to generate the first and second versions. In yet a further embodiment, the method further comprises configuring the mask to perform the area selection and signal modification. In another embodiment, different alterations are applied to the optical signal in the two areas.

In a further embodiment, the configuration of the mask is varied with time. In another embodiment, the mask comprises a plurality of regions, where each region is adapted to adjust at least one of an amplitude, phase, polarization, and dispersion of the optical signal. In yet another embodiment, the optical channel is an OAM fiber, and the two areas correspond to OAM modes of the OAM fiber. In another embodiment, the optical channel is a multicore fiber, and the two areas correspond to two different cores of the multicore fiber. In a further embodiment, the optical channel is one of a free space optics optical channel and a hollow core fiber wherein the mask performs a function corresponding to a holographic code.

In a second embodiment of the present invention, there is provided a method of transmitting an optical signal carrying data in an optical channel. The method comprises receiving the optical signal carrying data from a signal source; transmitting a version of the received optical signal in a first area of the optical channel; and transmitting an optical signal bearing noise in a second area of the optical channel, different than the first area.

In a third embodiment of the present invention, there is provided a method of receiving an optical signal transmitted as an obfuscated signal in an optical channel. The method comprises receiving first and second components of the obfuscated signal from first and second areas, respectively, of the optical channel; modifying the first component; and combining the modified first component and the second component to obtain a recovered optical signal.

In another aspect of the third embodiment, modifying the first component comprises altering at least one of amplitude, phase, polarization, and dispersion of the first component. In another embodiment, modifying the first component further comprises passing the obfuscated signal through a mask; and controlling the mask to perform at least one of selection and modification of the first component. In yet a further embodiment, controlling the mask comprises modifying the first component in a time-varying manner.

In a fourth aspect of the present invention, there is provided an optical transmitter comprising an obfuscation mask for spatially obfuscating an optical signal carrying data, and a controller for controlling the obfuscation mask to direct first and second versions of the optical signal into first and second two areas, respectively, of an optical channel.

In a further embodiment of the fourth aspect of the present invention, the optical transmitter further comprises an optical source for producing the optical signal. In another embodiment, the first version of the optical signal is different from the second version of the optical signal. In yet another embodiment, the controller is configured to control the obfuscation mask to select the first and second areas of the optical channel. In yet a further embodiment, the obfuscation mask comprises a plurality of regions, each region in the plurality adapted to adjust at least one of amplitude, phase, polarization, and dispersion of the optical signal. In an embodiment, the controller is adapted to control a first region of the plurality of regions to apply a first adjustment to create the first version of the optical signal and to control a second region of the plurality to apply a second adjustment, different than the first adjustment, to create a second version of the optical signal. In another embodiment, the controller is configured to vary the control of the obfuscation mask over time.

In yet another embodiment, the optical channel is an Optical Angular Momentum (OAM) mode fiber, and the two areas correspond to areas used in the propagation of an OAM mode. In a further embodiment, the optical channel is a multicore fiber optic channel, and each of the two areas correspond to cores in the multicore fiber optic channel. In yet a further embodiment, the optical channel is one of a free space optics channel and a hollow core fiber.

In a fifth aspect of the present invention, there is provided an optical receiver comprising a recovery mask for recovering a data-carrying optical signal from an obfuscated signal transmitted in an optical channel, and a controller for controlling the recovery mask to receive first and second components of the obfuscated signal from first and second areas, respectively, of the optical channel, and control the recovery mask to modify the first component and to combine the modified first component with the second component to obtain the recovered data-carrying optical signal.

In another embodiment, the controller is configured to control the recovery mask to modify at least one of amplitude, phase, polarization, and dispersion of the first component. In yet another embodiment, the controller is configured to apply a time varying modification to the first component. In yet a further embodiment, the controller is configured to control the recovery mask to select the first and second areas of the optical channel. In an embodiment, the recovery mask comprises a plurality of regions, each region in the plurality responsive to control signals from the controller to modify at least one of amplitude, phase, polarization and dispersion of incident light to create the first and second components.

### BRIEF DESCRIPTION OF THE DRAWINGS

These and other features of the disclosure will become more apparent from the description in which reference is made to the following appended drawings.

FIG. 1 is a block diagram of an optical system implementing physical layer obfuscation, according to some embodiments of the disclosure.

FIG. 2A is an illustration of a cross-section of an optical channel.

FIG. 2B is an illustration of an obfuscation mask for use with the optical channel of FIG. 2A, according to an embodiment of the disclosure.

FIG. 2C is an illustration of a recovery mask for use with the optical channel of FIG. 2A, corresponding to the obfuscation mask of FIG. 2A.

FIG. 3A is an illustration of a phase mask, according to an embodiment of the disclosure.

FIG. 3B is an illustration of another phase mask of FIG. 3A, according to an embodiment of the disclosure.

FIG. 4 is a set of phase masks that can be used to cause an optical signal to be propagated in an Orbital Angular Momentum (OAM) mode, according to an embodiment of the disclosure.

FIG. 5 is a schematic diagram of a photonic network where physical layer obfuscation can be implemented, according to an embodiment of the disclosure.

FIG. 6A is an example illustrating a received power of a signal at a receiver with a correct mask.

FIG. 6B is an example illustrating a received power of a signal at a receiver with an incorrect mask.

FIG. 7 is a flowchart illustrating a method of obfuscating a received signal at a transmitter.

FIG. 8 is a flowchart illustrating another method of obfuscating a received signal at a transmitter.

FIG. 9 is a flowchart illustrating a method of receiving an optical signal transmitted as an obfuscated signal at a receiver.

FIG. 10 is a flowchart illustrating another method of receiving an optical signal transmitted as an obfuscated signal at a receiver.

FIG. 11 is a flowchart illustrating a method of obfuscating the transmission of a data bearing signal.

FIG. 12 is a flowchart illustrating a method of recovering a data signal from an obfuscated signal.

### DETAILED DESCRIPTION

The following detailed description contains, for the purposes of explanation, various illustrative embodiments, implementations, examples and specific details in order to provide a thorough understanding of the disclosure. It is apparent, however, that the disclosed embodiments may be practiced, in some instances, without these specific details or with an equivalent arrangement. The description should in no way be limited to the illustrative implementations, drawings, and techniques illustrated below, including the exemplary designs and implementations illustrated and described herein, but may be modified within the scope of the appended claims along with their full scope of equivalents.

Disclosed herein is a method and apparatus which can be used to secure photonic layer links. The method and apparatus allow a data-carrying optical signal to be obfuscated spatially during transmission. A receiver, having knowledge of the spatial obfuscation can recover the data-carrying optical signal. An interloper without a priori knowledge of the particular obfuscation applied would not be able to detect the transmitted obfuscated signal, and thus would not be able to recover the data-carrying signal.

To explain how the optical signal is obfuscated, it will first be explained how the optical signal is transmitted through an optical channel with space domain available for transmission. An optical channel may be an optical fiber, and the optical signal can be transmitted through a specific area of the fiber. Conventionally transmission of an optical signal has been done through the core of the optical fiber. Some optical fibers have been developed to have multiple cores (so-called multicore fiber optic channels), while other fibers support transmission of multiple propagation modes (so-called multimode fiber optic channels). The optical fiber can also be an orbital angular momentum (OAM) mode fiber where transmission uses different modes corresponding to orbital angular momentums. As well, an optical fiber can be a hollow core optical fiber with a hollow core. An optical signal may also be transmitted through a free space optical channel using free space as the transmission medium.

An optical channel can be virtually divided into a plurality of areas in which the optical signal can be transmitted. When referring to an “area” in/into which the signal is transmitted, it should be understood that this refers to the area carrying the signal in a cross-section of the optical channel, or more generally a cross-sectional area that is substantially perpendicular to the direction of light propagation of the signal. In the disclosed method and apparatus, the optical signal is specifically placed into predetermined area(s) of the optical channel. The predetermined area(s) is not solely located inside the core of the fiber. The predetermined area(s) may include an area outside a core of the fiber, or exclude at least a portion of the core of the fiber. The predetermined area(s) may not be contiguous (e.g. the signal may be directed into disjoint areas of the fiber). Without knowing how the signal has been directed into the optical channel, it is not possible to recover sufficient signal power to reconstitute the signal.

The disclosed method and apparatus enables a physical layer or photonic transport layer signal obfuscation. Embodiments of the physical layer signal obfuscation, obtained instead of or in addition to digital encryption, may have several advantages. By achieving the physical layer signal obfuscation, the propagated signal is difficult to distinguish from noise. The obfuscation can effectively hide the signal in the optical channel. This makes recovery of the original signal difficult without an understanding or knowledge of the obfuscation. The obfuscated signal, as would be seen by an eavesdropper, will have a very poor or unacceptable signal quality, such as a poor optical signal-to-noise ratio (OSNR) or signal-to-noise ratio (SNR). The poor signal quality in itself conceals the transmitted signal, let alone the data carried by the signal. In other words, recovering a meaningful signal to reconstruct the data becomes a challenge on its own.

Because the obfuscated signal itself cannot be effectively buffered, it is more resistant to a brute force attack. According to the disclosed method and apparatus, the obfuscation of the data-carrying optical signal at the transmitter, and the de-obfuscation of the received signal at the receiver to recover the data-carrying optical signal can both be performed without regard to the data being carried by the optical signal. In some embodiments, the obfuscation of the data-carrying signal can be an analog process.

According to various embodiments of the disclosure, an optical signal is spatially obfuscated by transmitting the optical signal in predetermined area(s) of the optical channel. The location of the predetermined area(s) used for transmission as well as any alterations made to the transmitted optical signal in the predetermined area(s) are unknown to any party except the intended receiver. At the transmitter, the obfuscated signal can be obtained by passing the optical signal through an obfuscation mask (or a transmitter mask) which modifies the optical signal for transmission in the predetermined area(s). In the predetermined area(s), an alteration, or adjustment, can be applied to the optical signal, including, but are not limited to, the phase, amplitude, polarization and/or dispersion of the optical signal. The obfuscation mask is configured for transmission of the optical signal in the predetermined area(s). When the mask is configured, the location of the predetermined area(s) of the optical channel and any alteration to the optical signal in the predetermined area(s) are determined. At the receiver, the obfuscated signal is received and the data carrying signal can be recovered from the obfuscated signal by receiving the components of signal from predetermined area(s) and modifying the components of the obfuscated signal in the predetermined area(s). The recovery operation of the obfuscated signal can be performed by passing the obfuscated signal through a recovery mask (or receiver mask). By providing the receiver with the knowledge of the location of the predetermined area(s) used for transmission and any alteration made to the signal in the predetermined area(s), the optical signal carrying data can be recovered from the predetermined area(s) and any alteration applied at the transmitter can be compensated or reversed. As will be explained, the mask configuration of the obfuscation or recovery mask can be varied with time. By changing the mask configuration dynamically, it is more difficult for an eavesdropper to determine where in the optical channel the optical signal was transmitted and how it was transmitted at a given point in time.

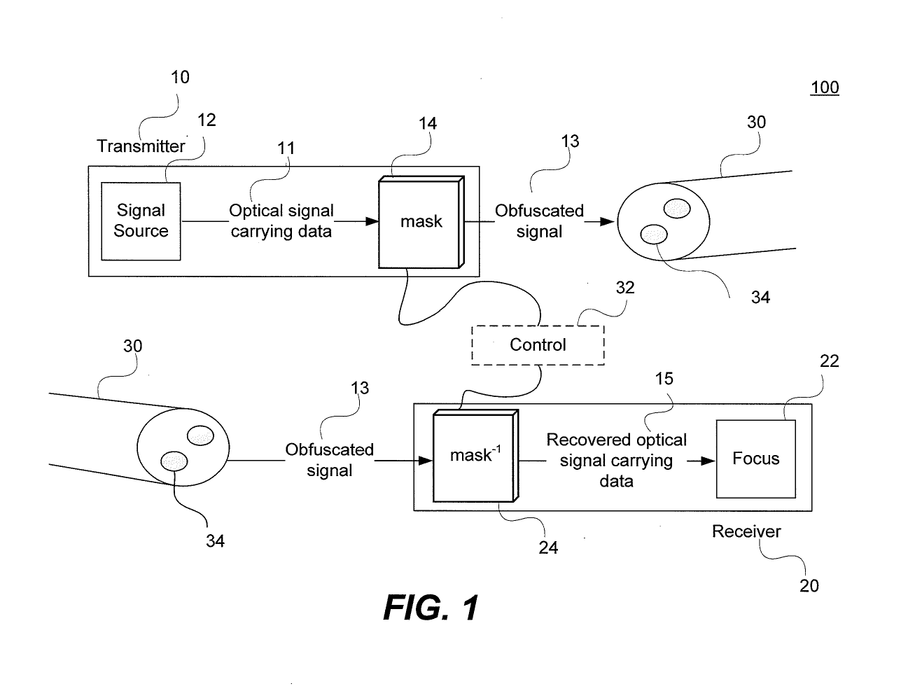

FIG. 1 is a simplified illustration of an optical system 100 carrying out the physical layer obfuscation, according to some embodiments of the disclosure.

An optical signal is transmitted from an optical transmitter 10 through an optical channel 30 to an optical receiver 20. At the transmitter 10, a data-carrying optical signal 11 is obtained from an optical signal source 12 (which may or may not be internal to the transmitter 10). The optical signal 11 can be passed through an obfuscation mask 14 which modifies the optical signal for transmission in predetermined area(s) 34 of the optical channel 30. The obfuscation mask 14 is used for spatially obfuscating the data-carrying optical signal 11 and is configured based on a mask configuration. By passing the optical signal 11 through the obfuscation mask 14 with a particular mask configuration, the optical signal 11 can be directed to the predetermined area(s) 34 of the optical channel 30 and alteration(s) can be applied to the optical signal in the predetermined area(s) 34, as will be explained. This modification results in an obfuscated signal 13 that is transmitted over the optical channel 30.

According to some embodiments, the optical signal 11 is transmitted in at least two areas 34 of the optical channel 30 and alteration(s) can be applied to the optical signal 11 in the at least two selected areas 34. Those skilled in the art will appreciate that in some instances reference will be made to applying adjustments to an optical signal, and that this should be understood as making an alteration to the signal. In this manner, different versions of the optical signal can be transmitted in the at least two areas 34. In one embodiment, a first version of the optical signal 11 is transmitted in a first area of the optical channel 30, and a second version of the optical signal 11 is transmitted in a second area of the optical channel 30. The first version can be a modified version of the optical signal 11. Modification applied to the optical signal 11 to create the first version can be an alteration of at least one of amplitude, phase, polarization, and dispersion of the optical signal 11. In an alternative embodiment, different alterations can be applied to the optical signal in the first and second areas. In another embodiment, the first area can be selected for transmission of a (modified or unmodified) version of the optical signal, and the second area can be used to transmit an obstruction signal, such as noise, a noise-like signal, a signal carrying false data and the like.

At the receiver 20, the obfuscated signal 13 is received and a recovery operation is performed on the obfuscated signal 13 to recover the optical signal. The obfuscated signal 13 is carried in at least two areas in the optical channel. Each of the predetermined area(s) 34 of the optical channel 30 carry a component of the optical signal. The recovery operation can include passing the obfuscated signal 13 through a recovery mask 24 for recovering a data-carrying optical signal from the obfuscated signal 13. The recovery mask 24 can be configured to compensate for the alteration or modification applied to each the optical signal 11. The recovery mask 24 is configured based on a mask configuration. By passing the obfuscated signal 13 through the recovery mask 24 with a particular mask configuration, the optical signal can be recovered from the predetermined area(s) 34 of the optical channel 30 and any alteration of the obfuscated signal in the predetermined area(s) 34 can be reversed. The recovery operation of the obfuscated signal can compensate for the modification applied by the obfuscation mask 14, and may additionally take into consideration propagation distortions occurring through the optical channel 30. The recovery operation results in a recovered data-carrying optical signal 15 and reaches the focus 22, which may be part of or connected to a receiving unit (not shown) for receiving the obfuscated signal 13 transmitted in the optical channel 30. Any appropriate techniques or signal processing can be used to properly recover the data-carrying optical signal 15 to compensate for the combined effect of the modification applied by the obfuscation mask 14 and propagation distortions occurring through the optical channel 30.

In one embodiment, the received obfuscated signal 13 can include first and second components. The first and second components are received from first and second areas, respectively, in the optical channel 30. The first component was transmitted as a modified version of the optical signal 11. At the receiver 20 and with such knowledge, the first component is modified and the modified first component can be combined with the second component to obtain a recovered optical signal 15. Modifying the first component can include altering at least one of amplitude, phase, polarization, and dispersion of the first component, to compensate for any alteration made at the transmitter 10. In an alternative embodiment, the second component may also have been transmitted as a modified version of the optical signal 11. In such a case, at the receiver 20, the second component can also be modified and combined with the modified first component in order to obtain the recovered optical signal 15. In another alternative embodiment, the obfuscated signal 13 can include a (original or modified) version of the optical signal in a first area of the optical channel 30 and an optical signal bearing noise in a second area of the optical channel 30, different than the first area. At the receiver 20, the recovery mask 24 can then be configured to pass the obfuscated signal 13 to drop the optical signal bearing noise from the second area of the optical channel 30 and obtain the recovered optical signal 15 from the first area of the optical channel 30. It will be understood that in some embodiments if a first component has been modified at the transmitting side, the recovery process may entail applying an offsetting alteration to the second component. One example of such a situation is when a phase shift has been applied to a first component, effectively resulting in a delay being applied to the first component. The application of an offsetting phase shift to the second component will allow the components to be combined to recover the signal.

The knowledge of where in the optical channel the optical signal is transmitted and how it was transmitted can be shared between the transmitter 10 and receiver 20, by way of a common control function 32 (which may be resident in one or both of the transmitter and the receiver, or in a third entity such as a Software Defined Networking controller). By ensuring that the transmitter 10 and receiver 20 are paired so that the transmitter is transmitting the signal in the same predetermined areas 34 in which the receiver is looking for the signal (or vice versa), the signal can be recovered from the predetermined area(s) 34 and any alteration applied to the predetermined area(s) 34 can be reversed. But to an interloper or eavesdropper, the signal is difficult to distinguish from noise and thus cannot be recovered. The configurations of the masks 14, 24 can be varied with time in the sense that the mask configurations are not static and can be changed dynamically. The configurations of the masks 14, 24 can be changed at fixed intervals, at points in time determined by the common control function 32, or after a predetermined amount of data is transmitted. The configurations of the masks 14, 24 can be controlled to change, entirely or partially, the area(s) 34 of the optical channel 30 used for transmission, and/or the alteration to the optical signal in the area(s) 34. The common control function 32 ensures that the configurations of the masks 14, 24 are paired.

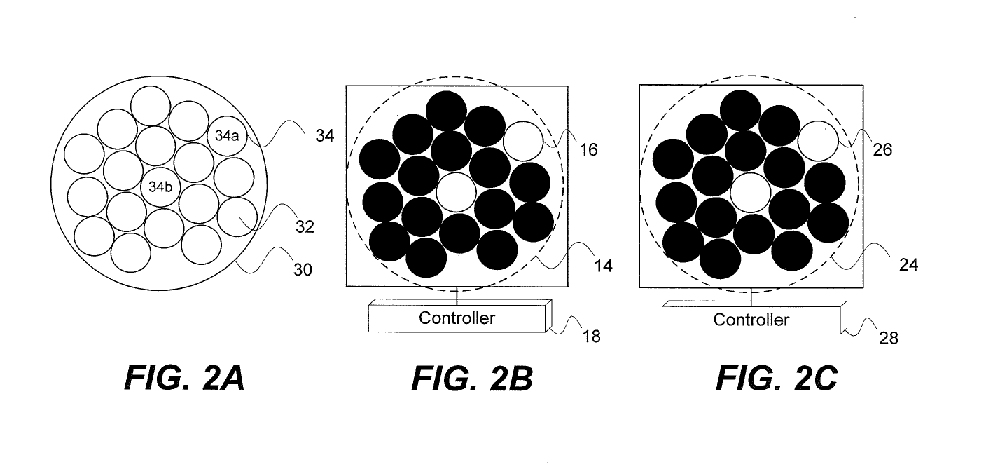

FIG. 2A is an illustration of a cross-section of an optical channel 30, the cross-section being virtually divided into a plurality of areas 32 in which the optical signal can be transmitted. The optical channel 30 can be a multicore fiber optic channel (in which case the areas 32 are cores of the multicore fiber), a multimode fiber optic channel, an OAM mode fiber, a hollow core optical fiber, or a free space optical channel. First and second areas 34a and 34b are indicated as the areas through which the optical signal is intended to be transmitted (these areas forming the predetermined areas 34).

FIG. 2B is an illustration of an obfuscation mask 14 for use with the optical channel 30 of FIG. 2A. As illustrated in FIG. 2B, the obfuscation mask 14 comprises a plurality regions 16 configured to allow transmission of the optical signal into the predetermined areas 34.

The obfuscation mask 14 is connected to a controller 18, in the form of for example, an electro-optic controller. In one embodiment, the controller 18 controls the obfuscation mask 14 to direct first and second versions of the optical signal 11 into first and second two areas 34a, 34b, respectively, of the optical channel 30. In particular, the controller 18 controls the obfuscation mask 14 to select the first and second areas 34a, 34b for transmission of the optical signal and to generate the first and second versions of the optical signal 11. The obfuscation mask 14 is configured by the controller 18 to perform the area selection and signal modification. In other words, the controller 18 controls the obfuscation mask 14 to select the location of the areas 34 of the channel 30 in which the optical signal to be carried and how the optical signal can be altered in the area(s) 34. Different alterations can be applied to the optical signal in the two areas 34a, 34b. Controller 18 can dynamically change the configuration of the obfuscation mask 14.

For instance, each of the regions 16 (or more specifically, the regions corresponding to the predetermined areas 34) can be adapted to adjust at least one of an amplitude, phase, polarization and dispersion of the optical signal. The alterations that are applied to the optical signal can be different in each of the predetermined areas 34.

In one embodiment, the obfuscation mask 14 can be an amplitude mask. In one simple configuration of an amplitude mask, each region 16 can have only two states, i.e., an open state and a closed state. A region in the open state can allow light to pass through; and a region in the closed state can block the incoming light. In this embodiment, it should be understood that even an open region may apply an amplitude attenuation to a portion of the signal incident upon the region. In another embodiment, the mask may direct the energy incident upon the “closed” regions into the area of the mask that corresponds to the “open' regions. This may result in the open regions transmitting a portion of the overall light incident upon the mask. Without knowing which area(s) of the optical channel carries the signal and how the signal is carried in the area(s), decoding the signal is difficult. In other embodiments, security may be further improved by transmitting signals in areas of the channel that corresponds to the “closed” regions. These transmitted signals are obstruction signals which may correspond to any of: noise, noise-like signals, signals carrying unimportant data, signals carrying false data. It will be understood that the arrangement of open and closed regions may be used to define the area(s) of the channel in which the signal is transmitted. In another embodiment, each region can apply one of a plurality of amplitude attenuations instead of a binary open/closed value.

In another embodiment, the mask 14 can be a phase mask. In one simple configuration of a phase mask, each region can have two phase states, e.g., an open state in which no phase shift is applied and a closed state in which a predefined phase shift is applied. In other embodiments, the phase shift applied by each region can be any one of a plurality of predefined phase shifts. By controlling the phase shift applied by each of the regions in the obfuscation mask 14, the signal can be propagated by exciting different propagation modes of the optical channel. In one embodiment as will be explained in more detail, the selection of a phase shifting configuration can result in the signal being propagated as a selected OAM mode.

In a further embodiment, both phase and amplitude can be modified at the same time. The selection of a particular configuration through the use of the amplification characteristic will direct the signal into the predetermined area(s) 34 of the optical channel. Each of the regions 16 in the obfuscation mask 14 corresponding to this predetermined area(s) 34 can then apply a phase shift. Each region can either apply the same phase shift, or at least one of the regions can apply a phase shift different than that applied by an adjacent region.

Other embodiments may make use of modifications, or alterations, related to the polarization, or dispersion (such as polarization mode dispersion (PMD), Chromatic dispersion (CD), etc) of the optical signal. It will be understood that other modifications to the signal, and combinations of the above can be applied by the mask. Phase, polarization and dispersion alterations may vary with the wavelength of the optical signal. In other words, the spatial obfuscation may also result in a frequency dependent alteration of the phase, polarization and dispersion of the optical signal.

In a simple implementation illustrated by FIG. 2B, the black filled regions shown in FIG. 2B can prevent transmission, while the unfilled regions of FIG. 2B can allow transmission into the predetermined areas 34. The black filled regions may be configured to direct at least some of the energy of the incident parts of the optical signal into one of the unfilled regions. The unfilled regions may apply a phase shift and/or an amplitude attenuation to the optical signal. The amount of the signal power transmitted through each of the areas 34a, 34b may not be the same.

FIG. 2C is an illustration of a recovery mask 24 for use with the optical channel 30 of FIG. 2A, corresponding to the obfuscation mask 14 of FIG. 2A.

At the receiver, the recovery mask 24 is configured to compensate for the modification applied by the obfuscation mask 14 and recover the data-carrying optical signal from the obfuscated signal transmitted in the optical channel. The recovery mask 24 also comprises a plurality regions 26, each region 26 can be controlled to adjust at least one of amplitude, phase, polarization, and dispersion of the obfuscated signal to undo the obfuscation caused by the corresponding region 16 of the obfuscation mask 14.

The recovery mask 24 is connected to a controller 28, in the form of for example, an electro-optic controller. The controller 28 is synchronized with the controller 18 of the obfuscation mask 14 and controls the recovery mask 24 to undo the obfuscation caused by the obfuscation mask 14. The controller 28 configures the recovery mask 24 to select the location of the predetermined areas 34 which the obfuscated signal is received from and how the obfuscated signal can be altered in these area(s) 34. The recovery mask 24 may not be a strict inverse of the obfuscation mask 14, as recovery mask 24 can also be used to compensate for known propagation effects to improve the recovery of the data-carrying optical signal. The pairing of the obfuscation mask 14 and the recovery mask 24 allows for an optical signal carrying data to be obfuscated in transmission and recovered at the receiver.

In one embodiment, the controller 28 controls the recovery mask 24 to receive first and second components of the obfuscated signal from first and second areas, respectively, of the optical channel. With the knowledge of the first component being transmitted as a modified version of the optical signal, the controller 28 can be configured to control the recovery mask 24 to modify the first component to be combined with the second component to obtain the recovered data-carrying optical signal. Alternatively, if the second component was also transmitted as a modified version of the optical signal, the controller 28 can be configured to control the recovery mask 24 to also modify the second component to be combined with the modified first component in order to obtain the recovered optical signal. The controller 28 controls the recovery mask 24 to select the first area for receiving the first component and the second area for receiving the second component. The mask can be configured to generate the modified component(s). Both the area selection and signal modification can be done by configuring the recovery mask 24. Controller 28 can dynamically change the configuration of the recovery mask 24.

When the obfuscation mask 14 is an amplitude mask, each region of the recovery mask 24 can be controlled to compensate the attenuation applied by the corresponding region. When the obfuscation mask 14 is a phase mask, each region of the recovery mask 24 can recover the phase offset of an incident portion of the obfuscated signal. When other modifications, or combinations of the above were applied by the obfuscation mask 14, a corresponding recovery can be performed by the recovery mask 24, with knowledge of the mask configuration.

In a simple implementation illustrated by FIG. 2C, the black filled regions shown in FIG. 2B can prevent reception, while the unfilled regions of FIG. 2B can allow reception from the predetermined areas 34. The unfilled regions recover any phase shift and/or amplitude attenuation applied at the transmitter. Both the particular areas 34a, 34b that are used, and any alteration of the optical signal that each area 34a, 34b applied, may be necessary to recover the original signal.

The configurations of the obfuscation mask 14 and recovery mask 24 are determined prior to transmission (i.e. “predetermined”). As illustrated, each region is individually controllable to provide a specified obfuscation or recovery. By increasing the number of regions of the masks, the number of possible patterns that can be used in the obfuscation is increased, thereby making it more difficult for an eavesdropper to determine the mask configuration.

The mask configuration may be static in operation, or alternatively, can be controlled to change dynamically. The controller 18 at the transmitter may be in communication with the controller 28 at the receiver so that the masks 14, 24 can be synchronized. Where the obfuscation caused by the obfuscation mask 14 (or correspondingly, the location of the areas 34 and the alteration of the optical signal in the area(s) 34) is varied with time, the controller 18 can be used to reconfigure the mask 14 through adjusting the obfuscation caused by each region 16. The change of the obfuscation mask 14 can be coordinated with the change of the recovery mask 24. For example, both the transmitter and receiver can receive information defining the mask configuration. The progression of geometric patterns of the mask over time may appear to be a random or pseudo-random pattern.

Any function that can be implemented at both transmitter and receiver and that is suitably secure can be used to determine when the mask configuration changes. In one embodiment, the transmitter and receiver can store a set of enumerated mask configurations. The transmitter and receiver can then be provided an instruction from the common control function to change to an identified mask configuration. In another embodiment, the control function may transmit an instruction to change the mask configuration, and include in the instruction the actual mask configuration. In such a scenario, it may be necessary for this control message to be encrypted. In another embodiment, an array of masks (e.g., each mask with a static spatial obfuscation) can be used and the desired mask can be dynamically selected.

In the embodiment illustrated in FIGS. 2A, 2B and 2C, the regions 16, 26 of the mask 14, 24 are circular in shape. However, it should be appreciated that the shape of the regions 16, 26 is not limited to a circular shape; other suitable shapes (such as rectangular) can be used. It should also be understood that the size of each regions 16, 26 in the mask 14, 24 may not be the same. Although in the example as illustrated in FIGS. 2A, 2B and 2C, the regions 16, 26 show a one-to-one correspondence to the areas 32 of the optical channel, it is to be understood that the one-to-one correspondence is not necessary and the regions 16 are configured, in any suitable manner, to direct the signal into the predetermined area(s) 34 of the optical channel 30.

The physical layer signal obfuscation in the various embodiments described above makes use of properties of the various optical channels. In some embodiments, the optical channels, such as OAM mode fibers or other multimode fiber optic channels include multiple spatial modes of propagation. A particular spatial mode of propagation can be selected (predetermined) to transmit the optical signal as the obfuscated signal. In such embodiments, the predetermined area corresponds to a predetermined OAM or propagation mode associated with the mask. If the obfuscation mask selects from either different OAM modes of an OAM mode fiber or different propagation modes of a multimode fiber optic channel, a corresponding recovery mask can recover the transmitted signal by having knowledge of the mode used for transmission. It should be noted that if a signal is obfuscated at the transmitter so that it propagates using an OAM mode of an OAM mode fiber or a propagation mode of a multimode fiber optic channel, the receiver must know the particular OAM or propagation mode that it is being transmitted in order to recover the signal.

An OAM mode fiber can allow transmission in different OAM modes. This is the equivalent of transmitting the signal in an annular region of the channel. Methods of transmitting data using OAM modes of propagation are discussed in J. Wang, et al., “Terabit free-space data transmission employing orbital angular momentum multiplexing Orbital Angular Momentum Multiplexing,” Nature Photonics., Vol. 6, July 2012; and C. Brunet, et. al., “Design, fabrication and validation of an OAM fiber supporting 36 states,” Optics Express, Vol. 22, Issue 21, 2014, both of which are incorporated by reference. It will be noted that the use of OAM modes is discussed in these references in the context of allowing transmission of multiple signals over the same channel. This is a form of spatial multiplexing that is intended to increase the capacity of a channel that supports transmitting in multiple OAM modes.

In accordance with one embodiment of the disclosure, the different spatial modes of propagation of an OAM mode fiber are utilized for obfuscating the transmitted optical signal.

When using an OAM mode fiber for transmission, the obfuscation mask 14 can be a phase mask or an amplitude mask. In either scenario, the predetermined area(s) 34 corresponds to a predetermined OAM mode. When the obfuscation mask 14 is a phase mask, each region 16 can be controlled to adjust the phase of an incident portion of the optical signal. The optical signal can be converted by the phase mask into an obfuscated signal that is propagated as an OAM mode through the optical channel. A corresponding recovery mask 24 is also a phase mask and each region 26 can be controlled to recover the phase offset of an incident portion of the received obfuscated signal. This way, the recovery mask 24 can convert the obfuscated signal into a recovered signal. When the obfuscation mask 14 is an amplitude mask, the regions 16 of the mask 14 can be used to direct the power of the optical signal to the predetermined area(s) 34. Correspondingly, the recovery mask 24 is also an amplitude mask and the regions 26 of the recovery mask can be used to direct the power of the received obfuscated signal from the predetermined area(s) 34.

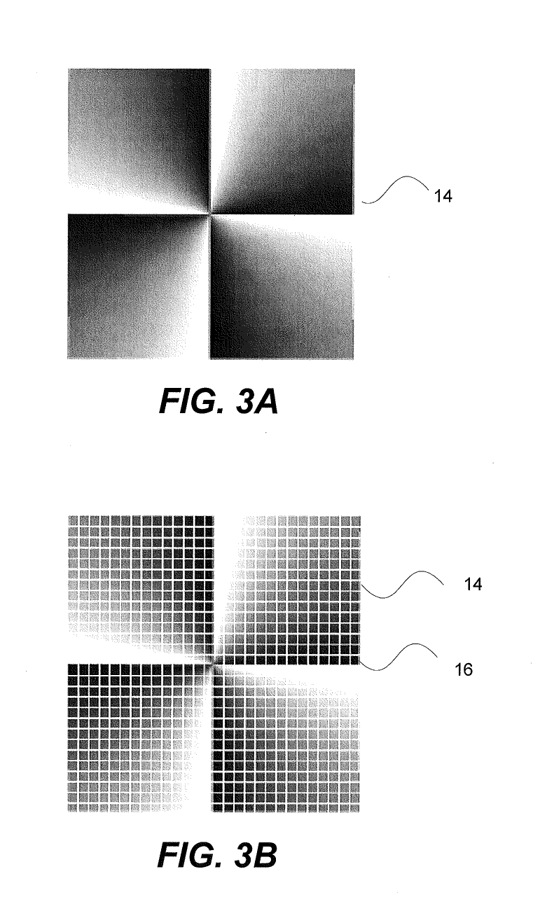

FIG. 3A illustrates a phase mask 14 that can be used to cause the propagation of an incident signal in an OAM mode. FIG. 3B illustrates another phase mask 14, where the regions 16 are multiplied compared to FIG. 3A.

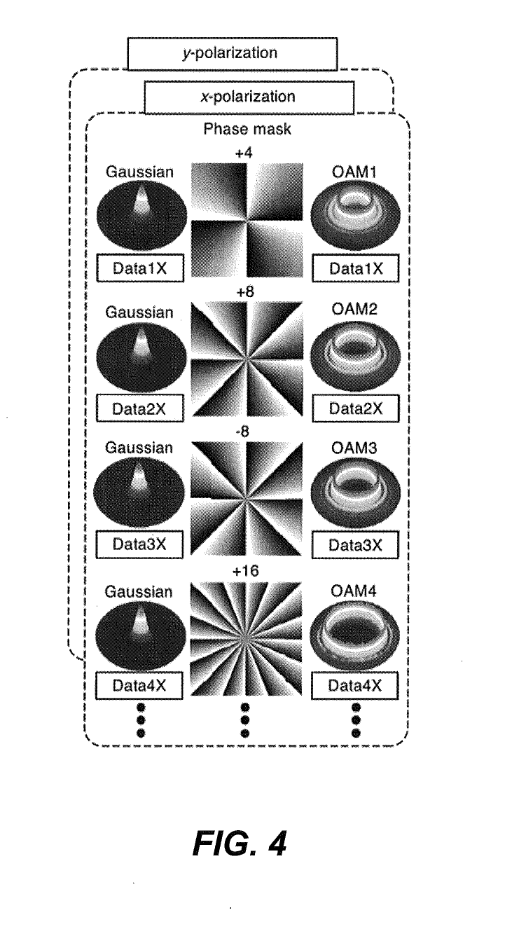

FIG. 4 illustrates a set of phase masks that can be used to cause the propagation of an incident signal in an OAM mode. FIG. 4 represents the input signal as a Gaussian distribution of signal power (on the left). When the optical signal is passed through a specific phase mask (shown in the center column), it will propagate through the channel as an OAM mode (shown at the right). A +4 phase mask will result in the signal being propagated in a first OAM mode. A +8 phase mask will result in the signal being propagated in a second OAM mode. −8 and +16 phase masks are also shown, along with the resulting OAM modes. Those skilled in the art will appreciate that, as shown in FIG. 4, when a phase mask is used to create OAM mode propagation, there is a corresponding phase mask that can recover the original signal at the receiver.

When a signal is transmitted in an OAM mode, recovery of the signal requires that the receiver knows the mode in which the signal is transmitted to allow for recovery. Without knowing the particular characteristics of the OAM mode (and other properties of the obfuscation), and/or the configuration of the recovery mask, recovery of the data bearing signal is difficult, if not impossible.

If an OAM mode is predetermined as the desired propagation mode, the effect is that the area(s) 34 of the optical channel onto which the power of the obfuscated signal is propagated has been predetermined. Without looking at the specific area(s) 34 of the optical channel and ignoring anything received in the balance of the channel, it is difficult to recover the input signal from the received obfuscated signal. Those skilled in the art will appreciate that if an optical channel supports multiple OAM modes, it is possible to transmit the obfuscated signal in one OAM mode, and obstruction signals (e.g. noise or other signals) in at least one other OAM mode. If an intercepting party is able to receive the obfuscated signal, they would be required to be able to successfully guess which OAM mode was being used for transmission. By varying the obfuscation mask over time, different OAM modes can be selected. Without knowledge of the timing of the change in the obfuscation mask, an intercepting party would be forced to constantly guess if the correct mode has been selected, further reducing the ability of an intercepting party to recover a useful signal.

Another mechanism for transmitting a signal in predetermined area(s) 34 of the optical channel 30, may be realized through the use of multicore fiber optic channels. In such embodiments, the regions of the obfuscation mask 14 can correspond to the location of cores in a multicore fiber. In such an embodiment, the optical signal carrying data is directed towards the obfuscation mask 14, which converts it into an obfuscated signal which is propagated through at least one of the cores. Different shares of the power of the optical signal can be carried by each of the selected cores by varying the attenuation of the signal at each of the regions corresponding to the selected cores. Different polarizations of the input signal could be transmitted using different sets of cores, and each core in use could carry a different percentage of the power of a given polarization.

In some embodiments, such as those making use of free space optical channels, or hollow core optical fibers, the obfuscation mask 14 may perform a function corresponding to a holographic code. An example of such a holographic code is discussed in the coding scheme in M. Abtahi, et al, “Spread-Space Holographic CDMA Technique-Basic Analysis and Application,” IEEE Trans. Wireless Comm., Vol. 1, No. 2, April 2002, the disclosure of which is incorporated by reference.

When the obfuscation mask 14 performs a function corresponding to a holographic code, the obfuscation mask 14 can be either an amplitude mask or a phase mask. Each region 16 corresponds to the randomly generated binary elements of the holographic code. For an amplitude mask, a region with binary element “1” can allow light to pass through (or with attenuation) and a region with binary element “0” can block the incoming light. In the area of the optical channel that corresponds to binary element “0”, destruction signal as described above, may be added to further obscure the optical signal. On the other hand, “0” and “1” for a phase mask can correspond to the addition of 0 or one or more predefined radians to the phase of the incident light, respectively.

The method and apparatus disclosed herein is wavelength agnostic. Different masks can be used for different wavelengths, or a single mask can be used for light occupying a portion of the spectrum or for light of different wavelengths bundled together. Accordingly, the method and apparatus can be incorporated at different locations of the photonic layer networks.

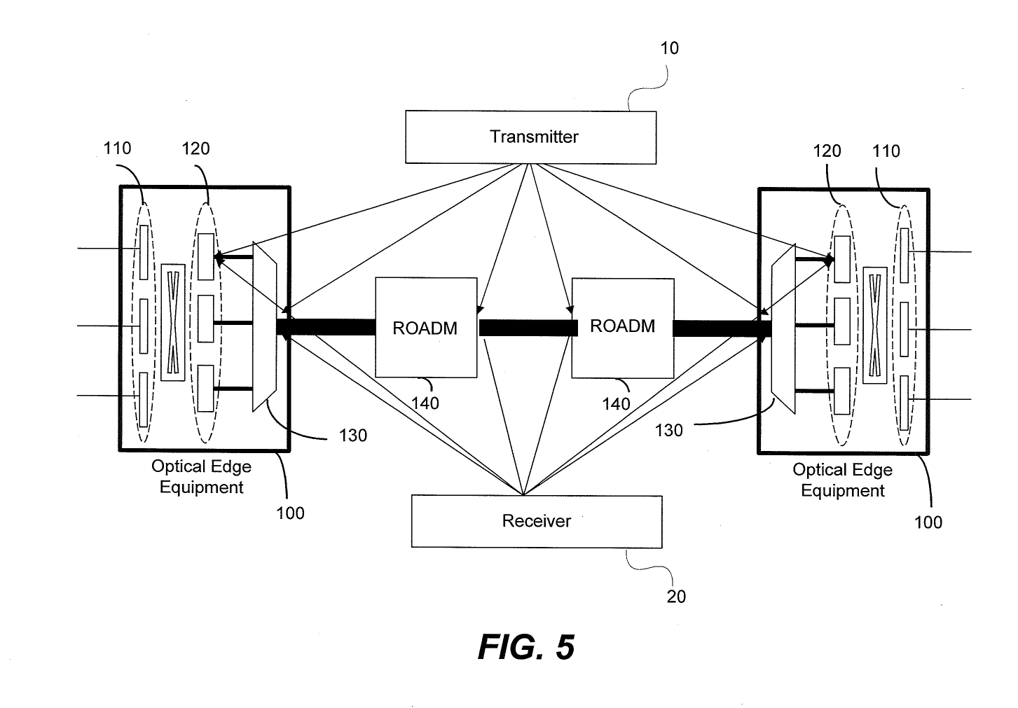

FIG. 5 is a schematic diagram of an example of a photonic network to illustrate where physical layer signal obfuscation can be implemented. In this example, the photonic network includes optical edge equipment 100 and reconfigurable optical add-drop multiplexers (ROADM) 140. The optical edge equipment 100 can include a plurality of Ethernet cards 110, optical cards 120, and multiplexers 130. Depending on a particular implementation, the transmitter 10 and/or receiver 20 equipped with the functionality as described above can be implemented at various locations of such a network structure.

In one embodiment, the transmitter 10 and/or receiver 20 equipped with the functionality as described above can be implemented at the output of the optical cards 120 in the optical edge equipment 100. In such an embodiment, masks can be used per wavelength and different masks can be applied to different wavelengths.

In another embodiment, the transmitter 10 and/or receiver 20 equipped with the functionality as described above can be implemented at the output of the multiplexers 130 in optical edge equipment 100. In such an embodiment, light of different wavelengths are bundled and can be processed in bulk using a single pair of obfuscation mask and recovery mask.

In yet another embodiment, the transmitter 10 and/or receiver 20 equipped with the functionality as described above can be applied at the ROADM 240.

By taking advantage of the ability of different optical channels to allow transmission of a signal in different areas, the disclosed apparatus and method allow for an optical transmission to be secured, regardless of the content of the signal.

The new additional hardware can be added on top of the existing transceivers technology to provide signal obfuscation. The method and apparatus is also transparent to modulation rate (10G, 40G, 400G, etc) and modulation scheme (Quadrature Phase Shift Keying (QPSK), dual—polarization QPSK (DP-QPSK), etc).

By using the disclosed method and apparatus, network providers can perform the obfuscation of a transmitted signal or signals at the physical layer at an all optical network (AON) node level for a specific wavelength, or for a portion of the spectrum. The method and apparatus separates the obfuscation function from the transponders and moves it to the photonic layer at the AON nodes. Security can be achieved when both AON nodes support the physical layer obfuscation. All subtending traffic channels can then benefit from such security feature. The disclosed method and apparatus can be used in applications of secure photonic networks implemented in a public fiber network infrastructure, such as in data center applications, and financial and government related traffic applications.

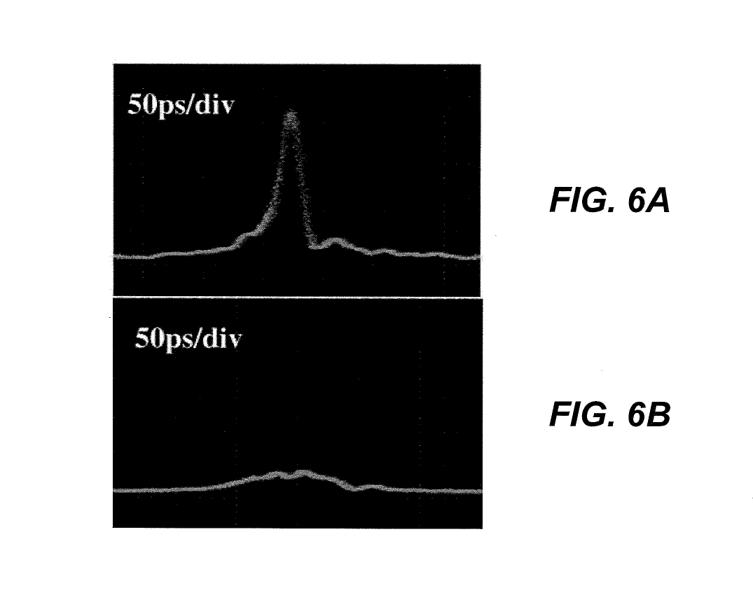

FIG. 6 illustrates an example of a received power of a signal at a receiver 20 with the correct mask (FIG. 6A) and an incorrect mask (FIG. 6B). Reference is made to Z. Wang et. al, “Improving the privacy of optical steganography with temporal phase mask,” Optics Express, Vol. 18, No 6, March 2010, where the result is provided in the context of a temporal phase mask applied to an optical signal. As shown in FIG. 6A, when the receiver has a phase mask that allows for compensation of the obfuscation caused at the transmitter, the recovered signal waveform is intelligible. As shown in FIG. 6B, the recovered signal is near or below noise thresholds when the phase masks are mismatched. As can easily be seen, without the ability to correct the obfuscation caused at the transmitter, the receiver will only see a noise-like signal.

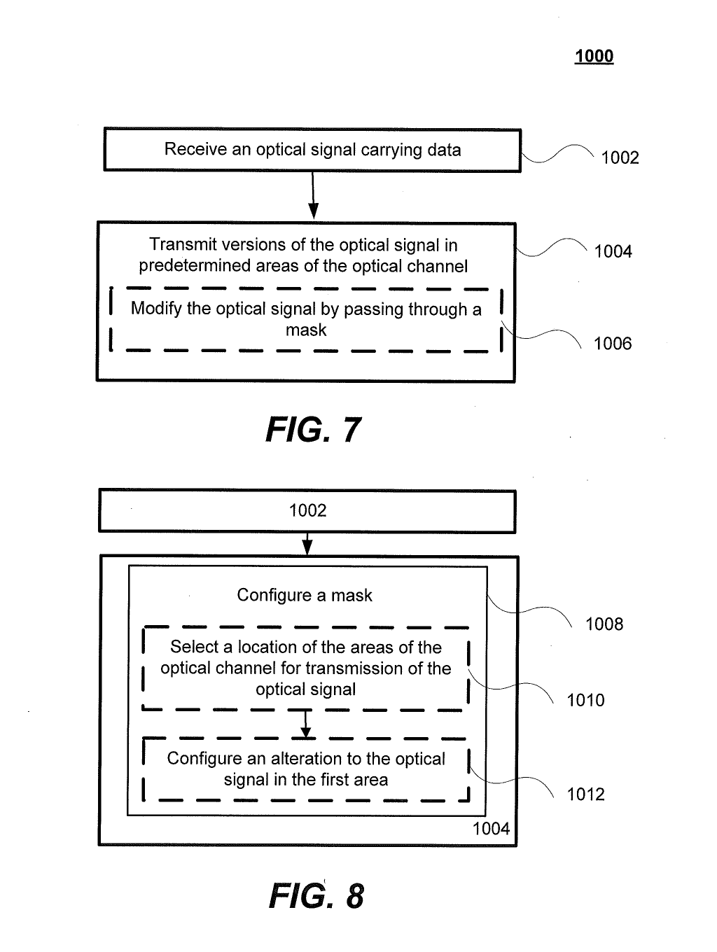

FIGS. 7-8 illustrate exemplary methods for obfuscating a received signal at a transmitter. In FIG. 7, the process (1000) starts with step (1002) in which an optical signal carrying data is received from a signal source. In step (1004), first and second versions of the received optical signal are transmitted in first and second areas, respectively, of the optical channel. As discussed above, the first version can be a modified version of the received optical signal, and the modification can be an alteration of at least one of amplitude, phase, polarization, and dispersion of the received optical signal. Step (1004) can further include a step (1006) of modifying the optical signal by passing the optical signal through a mask to select the first and second areas of the optical channel. Those skilled in the art will appreciate that the predetermined areas does not conform to the entirety of the core of an optical fiber.

An embodiment of the method set forth in FIG. 7 is illustrated in FIG. 8, but it should be noted that step (1004) includes step (1008) in which the mask 16 is configured. The step (1008) can further include selecting (1010) a location of the first and second areas of the optical channel (area selection) and configuring (1012) an alteration to the optical signal in the first area (signal modification). As discussed above, the mask configuration can be reconfigured, as discussed above, either at fixed intervals, at points in time determined by the controller, or after a predetermined amount of data is transmitted.

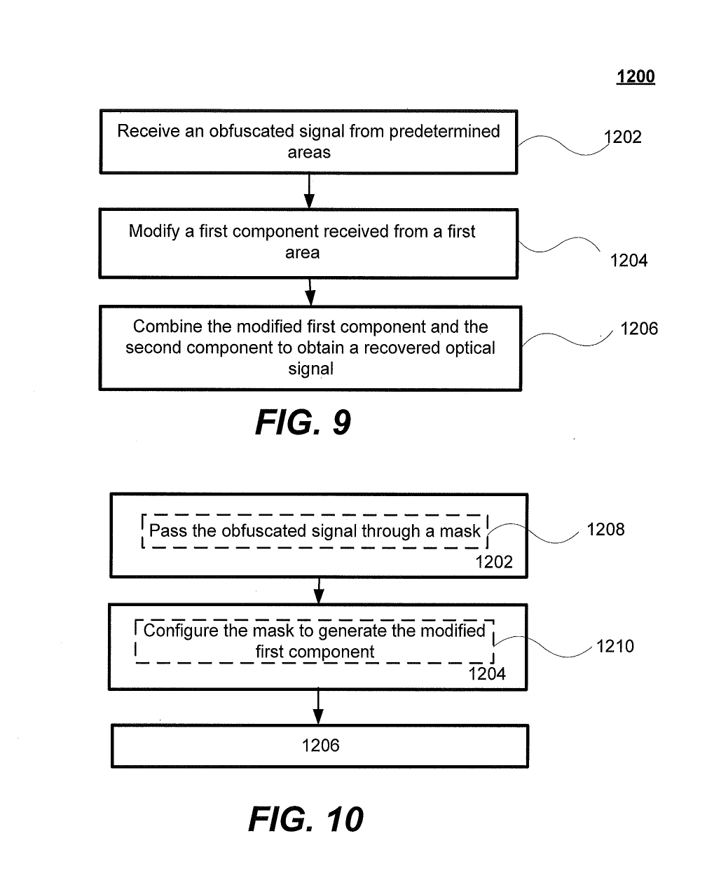

FIGS. 9-10 illustrate exemplary methods for receiving an optical signal transmitted as an obfuscated signal at a receiver. In FIG. 9, the process (1200) starts with step (1202) in which the receiver receives an obfuscated signal having first and second components, the first and second components received from first and second areas, respectively, in the optical channel. In step (1204) the first component is modified and combined (1206) with the second component to obtain a recovered optical signal.

An embodiment of the method set forth in FIG. 9 is illustrated in FIG. 10, but it should be noted that the step (1202) can further include a step (1208) of passing the received obfuscated signal through a mask to select the first area for receiving the first component and the second area for receiving the second component. The modifying step (1204) can be performed by configuring (1210) the mask to generate the modified first component. In other words, the mask is configured to perform the area selection and signal modification. The configuration of the mask in step (1210) can be an inverse in functionality of the mask used at the transmitter 10. This pairing of transmitter and receiver masks 14, 24 allows for the recovery of an optical signal carrying data. It will be understood that the recovered optical signal may differ from the original optical signal carrying data that is received at the transmitter due to propagation effects, such as dispersion. The mask used in step (1210) may additionally be configured to take into consideration propagation distortions so that the data-carrying optical signal can be recovered. As discussed above, the mask configuration can be reconfigured, as discussed above, either at fixed intervals, at points in time determined by the controller, or after a predetermined amount of data is transmitted. The reconfiguration of masks is synchronized between the transmitter and the receiver.

Those skilled in the art will appreciate that with reference to the above disclosed embodiments, the transmission of different versions of the data bearing signal in different areas of the optical transmission channel allows for security when an intervening party does not have knowledge of how the versions of the signal differ from each other. In a simple example, if the optical channel is a multicore fiber, one fiber core can be used to transmit a component of the original signal, while a second core can be used to transmit a second component that is identical to the first component save for a π/2 phase shift. An intercepting party that simply summed the components would end up cancelling the signal out. Other examples will be apparent to those skilled in the art. The example of a multicore fiber provides one of the easiest to understand implementations of transmission through an area of the fiber. It will be understood that reference is made to an area of transmission because of how it appears in cut-away figures. A region of the fiber is an alternate phrase, but may result in confusion with the use of region to denote a component of the mask. In a multimode fiber, or an OAM mode fiber, the area or region of the optical channel that is used for each component may not be as clearly differentiated as they are in the multicore example. It may provide assistance to the reader to think of the areas in non-multicore examples as being virtual areas in which different versions of the signal are transmitted. It will be further understood by those skilled in the art that the transmission of the different versions in different areas of the channel may appear to an outside observer as a differential dispersion of the signal into the transmission regions of the channel.

In another embodiment, a degree of security can be achieved through selecting an area of the optical channel in which to transmit the signal, transmitting an optionally modified version of the data carrying signal in that area, and then transmitting a noise bearing signal in at least one other transmission area of the channel. In effect, without knowing the selected area, and the changing modification applied to the signal, anyone intercepting the signal would not be able to recover the original data bearing signal. Those skilled in the art will appreciate that any number of the other areas can be used in this manner. As more areas are used to carry noise bearing signals, the ability of an intervening party to identify a signal is diminished. In some embodiments, any noise signal can be used (e.g. Gaussian noise), but in other embodiments the characteristics of the noise signal will be tailored to more closely resemble the parameters of the data bearing signal. This will make it more difficult for an intercepting party to identify the particular area in use. Because the transmission mask can be controlled, the selected area used for transmitting the version of the signal can be changed.

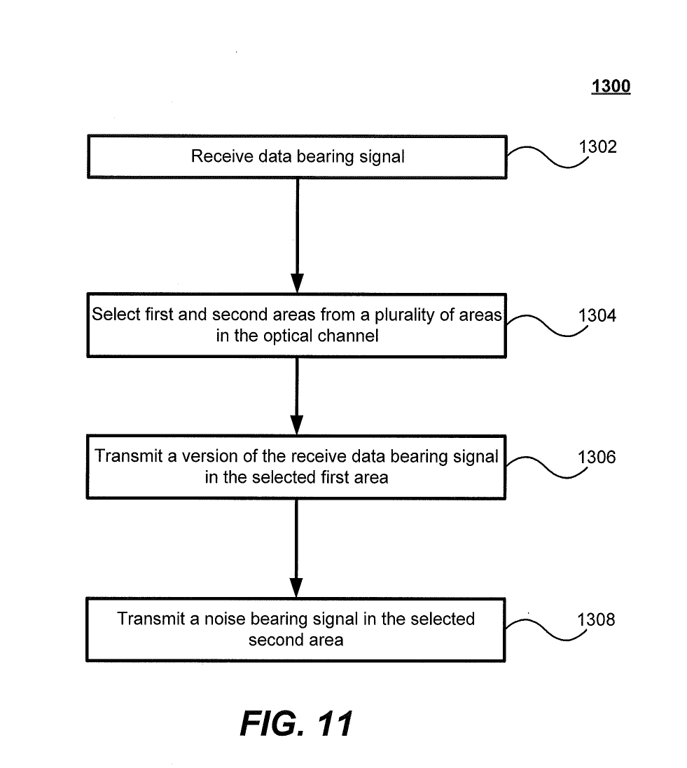

FIG. 11 illustrates a method (1300) for carrying out the above described obfuscated transmission. In step (1302), a data bearing signal is received. In step (1304) first and second areas are selected from the plurality of areas in a channel. In step (1306), a version of the received data bearing signal is transmitted in the first selected area. As noted above, the selection of the first area and the transmission of the data bearing signal in the first area can be performed as discussed above with the use of a mask. In step (1308), a noise bearing signal is transmitted in the second selected area. In some embodiments, the noise bearing signal can be created by controlling the region of the mask corresponding to the second area so that a pseudo random signal is imposed upon the data bearing signal. This will result in the version of the data bearing signal becoming a noise bearing signal. The control information used to create the pseudorandom pattern in the region corresponding to the second area does not need to be transmitted to the receiver. The receiver can disregard all signal components other than the one received from the first selected channel area.

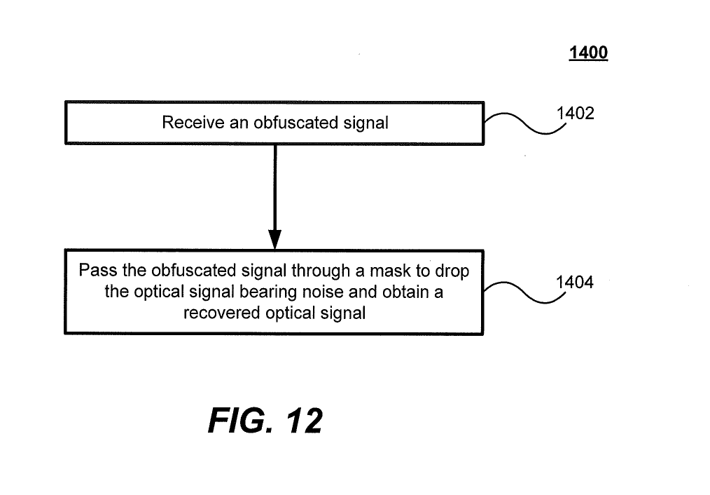

The methods discussed above with respect to recovering a signal from the obfuscated signal can be illustrated in FIG. 12. The method (1400) includes receiving (1402) the obfuscated signal. The obfuscated signal includes a version of the optical signal in a first area of the optical channel and an optical signal bearing noise in a second area of the optical channel, different than the first area. In step (1404), the obfuscated signal is passed through a mask to drop the optical signal bearing noise from the second area of the optical channel and obtain a recovered optical signal from the first area of the optical channel. This can be done by configuring the mask (as indicated in step 1210) that allows the receiver to drop all signals received outside of the first selected area and blocks out the noise bearing areas.

It should be understood that the transmission of noise bearing signals can be combined with the above methods so that a plurality of versions of a data bearing signal are transmitted in selected areas, with noise bearing signals carried in the other areas. In such an embodiment, the receiver could function as described in FIGS. 9 and 10.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g., “such as”) is intended merely to better illustrate or describe embodiments of the disclosure and is not intended to limit the scope of the disclosure unless otherwise claimed.

Although several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of transmitting an optical signal carrying data in an optical channel, the method comprising:
receiving the optical signal carrying data from a signal source; and
transmitting first and second versions of the received optical signal in first and second areas, respectively, of the optical channel.

2. The method of claim 1 wherein the first version is a modified version of the received optical signal.

3. The method of claim 2 wherein modification applied to the received optical signal to create the first version is an alteration of at least one of amplitude, phase, polarization, and dispersion of the received optical signal.

4. The method of claim 1, wherein transmitting comprises
modifying the optical signal by passing the optical signal through a mask to select the first and second areas of the optical channel.

5. The method of claim 4 wherein transmitting further comprises controlling the mask to generate the first and second versions.

6. The method of claim 5, further comprising configuring the mask to perform the area selection and signal modification.

7. The method of claim 6, wherein different alterations are applied to the optical signal in the two areas.

8. The method of claim 6, wherein the configuration of the mask is varied with time.

9. The method of claim 4, wherein the mask comprises a plurality of regions, where each region is adapted to adjust at least one of an amplitude, phase, polarization, and dispersion of the optical signal.

10. The method of claim 1, wherein the optical channel is an Optical Angular Momentum (OAM) fiber, and the two areas correspond to OAM modes of the OAM fiber.

11. The method of claim 1, wherein the optical channel is a multicore fiber, and the two areas correspond to two different cores of the multicore fiber.

12. The method of claim 4, wherein the optical channel is one of a free space optics optical channel and a hollow core fiber, and wherein the mask performs a function corresponding to a holographic code.

13. A method of transmitting an optical signal carrying data in an optical channel, the method comprising:
receiving the optical signal carrying data from a signal source;
transmitting a version of the received optical signal in a first area of the optical channel; and
transmitting an optical signal bearing noise in a second area of the optical channel, different than the first area.

14. A method of receiving an optical signal transmitted as an obfuscated signal in an optical channel, the method comprising:
receiving first and second components of the obfuscated signal from first and second areas, respectively, of the optical channel;
modifying the first component; and
combining the modified first component and the second component to obtain a recovered optical signal.

15. The method of claim 14, wherein modifying the first component comprises altering at least one of amplitude, phase, polarization, and dispersion of the first component.

16. The method of claim 14, wherein modifying the first component further comprises:
passing the obfuscated signal through a mask; and
controlling the mask to perform at least one of selection and modification of the first component.

17. The method of claim 16, wherein controlling the mask comprises modifying the first component in a time-varying manner.

18. An optical transmitter comprising:
an obfuscation mask for spatially obfuscating an optical signal carrying data, and a controller for controlling the obfuscation mask to direct first and second versions of the
optical signal into first and second two areas, respectively, of an optical channel.

19. The optical transmitter of claim 18, further comprising an optical source for producing the optical signal.

20. The optical transmitter of claim 18, wherein the first version of the optical signal is different from the second version of the optical signal.

21. The optical transmitter of claim 18, wherein the controller is configured to control the obfuscation mask to select the first and second areas of the optical channel.

22. The optical transmitter of claim 18, wherein the obfuscation mask comprises a plurality of regions, each region in the plurality adapted to adjust at least one of amplitude, phase, polarization, and dispersion of the optical signal.

23. The optical transmitter of claim 22, wherein the controller is adapted to control a first region of the plurality of regions to apply a first adjustment to create the first version of the optical signal and to control a second region of the plurality to apply a second adjustment, different than the first adjustment, to create a second version of the optical signal.

24. The optical transmitter of claim 18, wherein the controller is configured to vary the control of the obfuscation mask over time.

25. The optical transmitter of claim 18, wherein the optical channel is an Optical Angular Momentum (OAM) mode fiber, and the two areas correspond to areas used in the propagation of an OAM mode.

26. The optical transmitter of claim 18, wherein the optical channel is a multicore fiber optic channel, and each of the two areas correspond to cores in the multicore fiber optic channel.

27. The optical transmitter of claim 18, wherein the optical channel is one of a free space optics channel and a hollow core fiber.

28. An optical receiver comprising:
a recovery mask for recovering a data-carrying optical signal from an obfuscated signal transmitted in an optical channel, and
a controller for controlling the recovery mask to:
receive first and second components of the obfuscated signal from first and second areas, respectively, of the optical channel, and
control the recovery mask to modify the first component and to combine the modified first component with the second component to obtain the recovered data-carrying optical signal.

29. The optical receiver of claim 28, wherein the controller is configured to control the recovery mask to modify at least one of amplitude, phase, polarization, and dispersion of the first component.

30. The optical receiver of claim 28, wherein the controller is configured to apply a time varying modification to the first component.

31. The optical receiver of claim 28, wherein the controller is configured to control the recovery mask to select the first and second areas of the optical channel.

32. The optical receiver of claim 28, wherein the recovery mask comprises a plurality of regions, each region in the plurality responsive to control signals from the controller to modify at least one of amplitude, phase, polarization and dispersion of incident light to create the first and second components.
